(19) United States
(12) Patent Application Publication
(10) Pub. No.: US 2016/0318498 A1
(43) Pub. Date: Nov. 3, 2016

(54) MULTI ROTOR AIRTRAIN

(71) Applicant: Brian Lee Uitdenbogerd, Rosemount, MN (US)

(72) Inventor: Brian Lee Uitdenbogerd, Rosemount, MN (US)

(21) Appl. No.: 14/698,261

(22) Filed: Apr. 28, 2015

(51) Int. Cl. B60V 3/08; B64C 27/24; B64C 27/26

(52) U.S. Cl. CPC B60V 3/08; B64C 27/26; B64C 27/24

(57) ABSTRACT

The Future AirTrain is Mass Transport Ground Effect Vehicle (MTGEV), The multi copter combining with the patent pending AirTrain or symmetrically joined Airliners design, is best for the class III Ground Effect Vehicle, it can operate in out of ground effect close to any surfaces, roads, body of water, dessert, ice and snow. At the same time it can operate at a high altitude to clear any size obstacles such as mountains. AirTrain is the combination of airliner technology, multi copter technology and unmanned aerial, UAV, technology. The AirTrain is the new concept of speed train and new mode of transportation operate in and out of ground effect safely to give the most efficient in the fuel economy, carry almost the twice as many cargo and passengers at any environment and weather conditions.

AirTrain, the world's a super sized the first commercial Ground Effects Vehicle. As it is shown in the FIG. 1 below is the actual working model, symmetrically joined two airliners is combined with the quad copter technology and unmanned areal technology are combined to make the AirTrain to operate at low altitude much more safer and with control. AirTrain with the four horizontal quad copter engines and with additional one or two engines for propelling horizontal trust would give the AirTrain to give much more stability, control and also the speed.

### BACKGROUND OF THE INVENTION

The worlds global emission is growing each year. Just in the United States alone the Co2 total emission from cars, trucks, buses and other equipment is whopping 79 percent. The bad news is that other countries that are growing rapidly are catching up to the United States emission out put. Co2 emission is the major cause in the global warming and we need to do some thing to curve and control the Co2 emission by utilizing more of mass transportation systems such as rail system, which is 2% of the global emission. Rail system includes the speed trains and recent years the speed trains have gained much popularity and technologically advanced. However, the cost to build the infrastructures is in the billions of dollars. A good example is magnet-lift, speed train systems infrastructures to connect Victorville, Calif. to Las Vegas, Nev. costs estimated to be in the 60 billions of dollars. As one can see that the speed trains are nice to have but it is cost prohibitive. This is where the AirTrain comes in is that AirTrain is like speed train without any infrastructures. No infrastructures are required and it is safe, similar speed or greater, can carry similar loader greater flying near the ground in a ground effect without any wheels and rails.

### BRIEF SUMMERY OF THE INVENTION

New patent pending technology, AirTrain and Symmetrical Airliner, combine with the multi copter technology and unmanned aerial vehicle technology (UAV).

The prior Art Unit 3644 and 3617, two same types of airliners joined symmetrically joined be set balanced on top of the quad copter as seen on the diagram.

The FIG. 1. is the actual working model in scale of 1/144. Multi copter AirTrian that can fly in ground effect, effectively take off vertically, altitude hold, forward, back, row and yaw, go up and down.

Multi copter, it means that it uses two more propellers on any location. In the FIG. 1 is a multi copter, it has four propellers thus, it is a quad copter combined with two symmetrically connected Airliner fuselages are places on top of the quad copter that is most balanced.

The number of propellers requirement is determined and placed that are best for the total balance, performance and efficiency to power the Multi Copter AirTrain in all directions of movements safely and effectively.

Propellers can be any size or shape, location that is will give the most balance and effectiveness. See, FIGS. 2-6 below are Quad Copter AirTrain design for the best balance and for safety.

The Propeller engines can be any type of engine that is most suited for operating at a low altitude to give the best performance in the ground effect at the same time provide more than adequate lift of the two airliner fuselage on top. See FIGS. 1-6.

The numbers of propellers used are not set but it is determined by the most effective means to safely operate the quad copter that will give the most performance in the balance and in ground effect.

It has all the capability and futures of a quad copter to move symmetrically joined airliner, forward, back, yaw, row, turn, and vertical, down, up movement. Speed control, perfect control of the speed, just like a car, it can stop and hover.

It can do a vertical take off, speed at any desired setting, it can slow down to any speed, and dead stop.

Quad copter is used for altitude hold safely maintaining the set, to maximize the ground effect distance and it will help the AirTrain to go in and out of ground effect.

It can do GPS hold at any altitude and locations safely at any where. It can hold at desire altitudes hold as needed and even do a GPS hold it would hold it desire altitude and at a GPS point at any time and during all adverse weather conditions.

The frames, 2. Frames can be made of floating, light and strong material so it can land at any surface including the water for any emergency landings and take offs.

The 2. Frames are placed to best support the propellers its effectiveness and efficiency.

The 2. frames can be made of super buoyant material to help keep afloat of the Multi Copter AirTrain in case when it makes an emergency landing.

The frames are light but strong material to help keep the two airliners together but at the same time we provide quad copter its foundation for the, control system, engines and for the rotors. See Pictures 1-5.

Horizontal engines can be a jet, turbo prop or any type of engines that is most effective in operating at low altitude to provide the forward trust at any altitudes.

Horizontal engines are mounted where it will give most forward thrust working with the quad copter to give most efficiency and effectiveness.

Airplanes parts and functions will work jointly with the quad copter to give it the better control and quicker response.

Airliner parts and function can be modified that will work best with the quad copters.

The winglets will have both pointing down and up. Winglets up will give a better lift performance and winglets pointed down will give the better ground effect performance.

Unmanned area vehicle, UAV, the most updated technology is incorporated to give the AirTrain the most technologically advanced fly using a i-pad or similar device to plan its routes and fly using the UAV technology.

AirTrain can be programmed locally by pilots before their scheduled departure or it will be monitored and controlled remotely from a multiple points to control and monitor the AirTrain performance, control and its movements its planned travel.

AirTrain will have one or two cockpits, one in the front or one on each end to for the pilots to monitor and control the AirTrain manually incase if the digital systems fail.

If the digital or analog systems fail or any major controls fail or unsafe is detected, it would safely land.

### BRIEF DISCRIPTION OF DRAWINGS

FIG. 1, is top view of multi copter, quad copter unmanned areal vehicle combined with prior patent pending arts of symmetrically joined airliner.

FIG. 2, is top view of how the propellers can be made smaller and attached in near the center of gravity where the two airliners are joined.

FIG. 3, is the side view to show how the propellers are placed at the bottom portion of the fuslage.

FIG. 4, is the side view to show how the propellers are placed at the top portion of the fuselage.

FIG. 5, is the side view to show both the propellers are placed on both top and bottom to get more power out put from the propellers.

FIG. 6, is the top view how the properllers can be placed inside the major wings.

FIG. 7, is the side view of the winglets to show that winglets area need to be covered both at the top and the bottom.

### DESCRIPTION OF EMBODIEMENTS

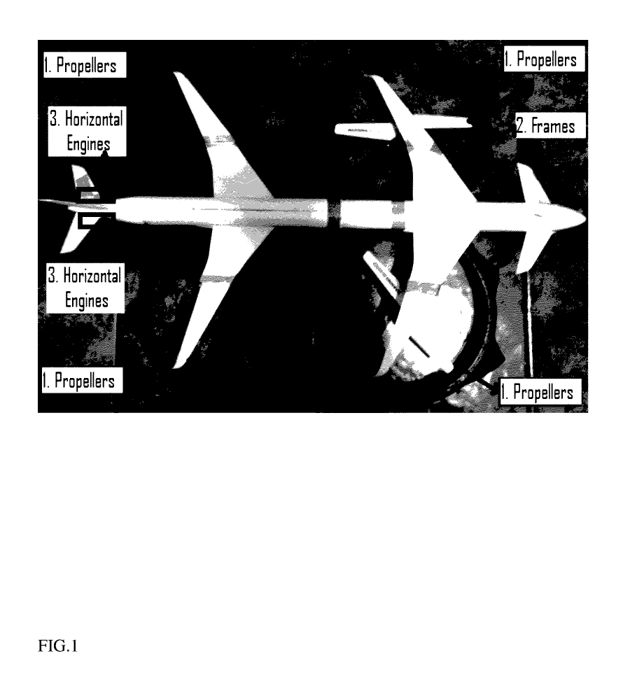

FIG. 1, is the actual Multi Rotor AirTrain in the scale of 1/144. If this is the best configuration, it should make it this way but making the propellers smaller and using the frames to attach the different part of the fuselage for the best balance and performance is better. The smaller the propellers would be better for the aerodynamics performance.

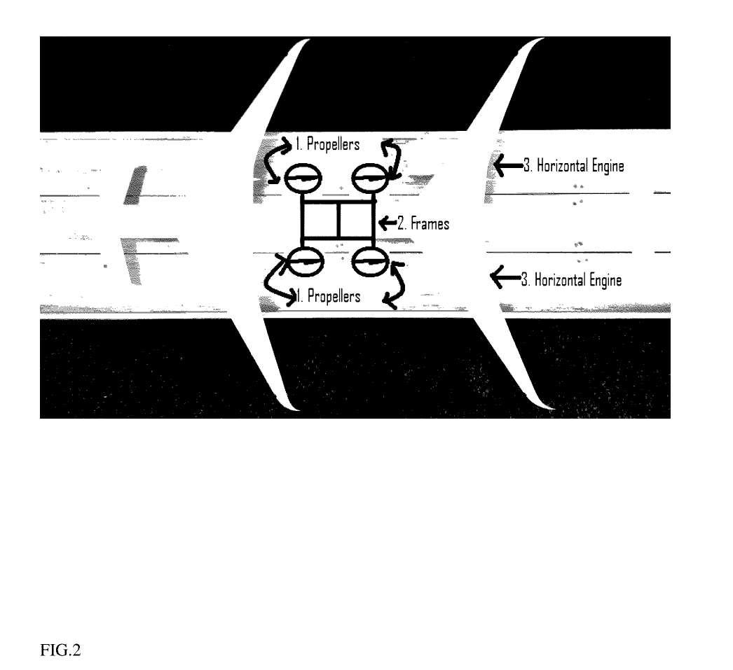

In FIG. 2, Horizontal Engines can one one, two or more, best locations to integrate to quad-copters to give its best performance, effectiveness and efficiency.

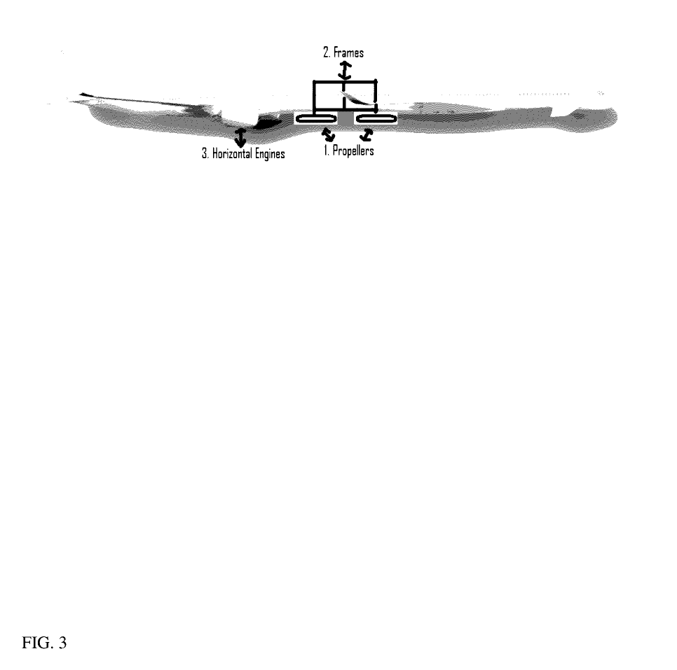

In FIG. 3, Quad copters propellers, 1, are mounted on the bottom if it gives its best performance and control.

The locations of propellers can be any part of the AirTrain to give its most performance, effectiveness and efficiency.

Frames, 2, are arranged and mounted where it will give the best performance to the propellers 1.

Frames, 2, are placed to strengthen the two airliners joint from constant flexion and inflexion to prevent the structural, fuselage failure.

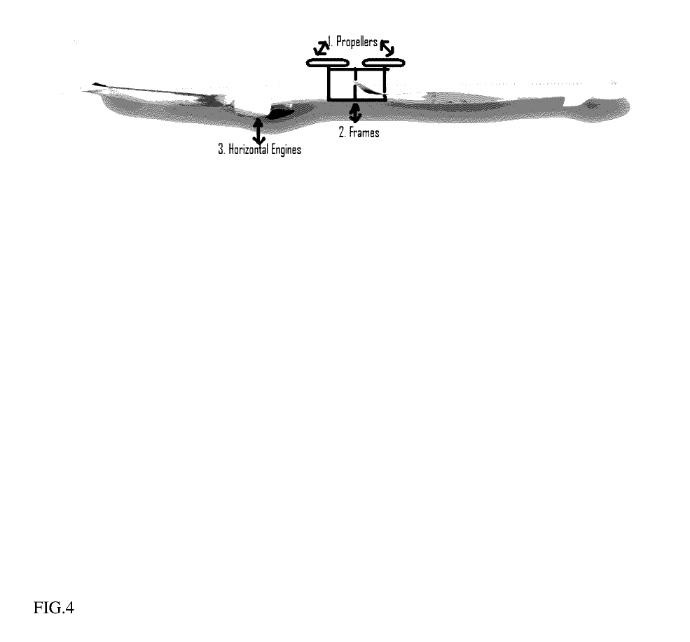

FIGS. 4, Quad copters propellers, 1, are mounted on the top if it gives its best performance and control. The locations can be any part of the AirTrain to give its most performance, effectiveness and efficiency.

FIGS. 2-6 Horizontal Engines can one or more, best locations to integrate to quad-copters to give its best performance, effectiveness and efficiency.

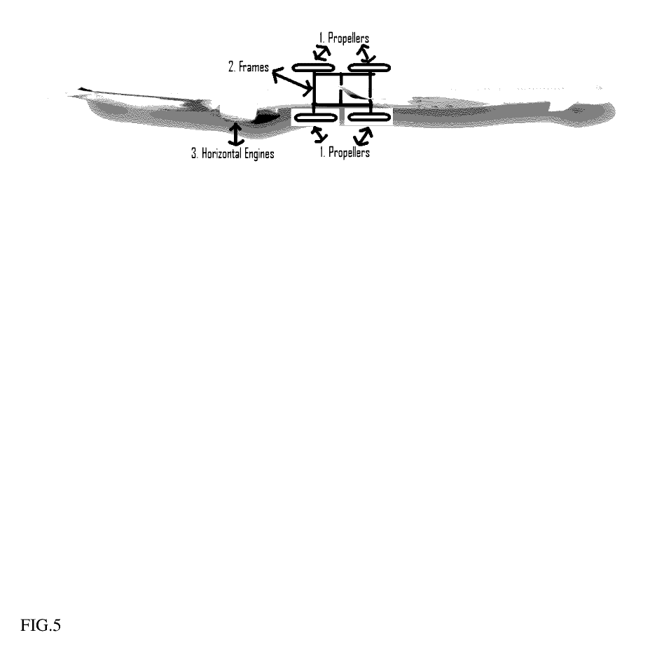

FIGS. 5, For the more strong performance of the quod copters trust out put, the propellers can be mounted 2 at the top and 2 at the bottom. It can be mounted in direct alignment and indirect alignment in any part of the AirTrain that will give the best performance and its effectiveness.

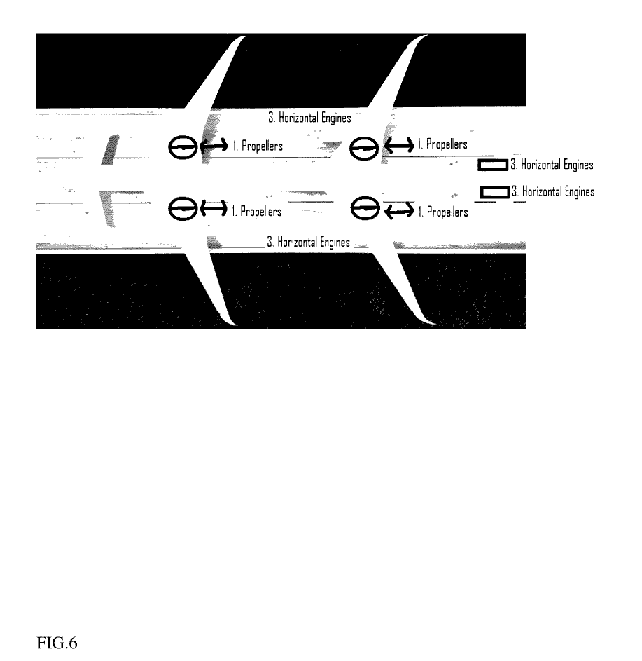

FIGS. 6, The propellers are imbedded on each other major four wings.

Their will be much flexion and inflexion of the front and back airliner parts there for the frames and the joint, where the two airliners are strengthen and at the same time, it limits the power and movements so that it is not creating the structure failure.

FIGS. 2-6, horizontal engines can one or more and mounted any part of the AirTrain to give its best performance.

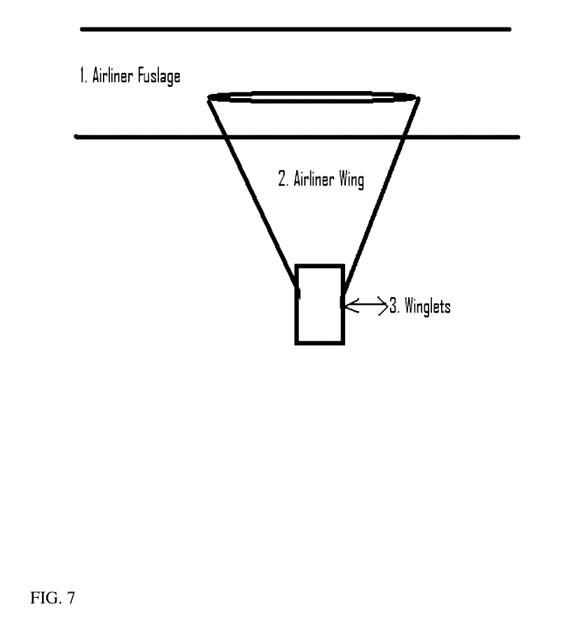

FIG. 7, the winglets should cover both the top and bottom part, top part will improve the airflow in the air but bottom will improve the ground effect in ground effect.

All Multi Roator AirTrain will have the simple check systems to check its indicators and smart sensors to monitor its performance and equipment

### INDUSTRIAL APPLICABILITY

It can safely haul cargo and passenger at almost twice as many passengers of any airliner types because two of the same airliners are joined to build AirTrains.

AirTrain operates most of its flight in ground effect that may give 1% or more efficiency, less fuel used per trip and 1% plus co2 emissions than a conventional airliner.

It is built using the used, retiring or retired airliners thus; the cost is significantly cheaper, ¼ of the cost to build than an airliner.

AirTrain uses combination of Airliner, multi copter with unmanned areal vehicle (UAV) technology, thus it will have a control and functions like a helicopter. At the same time it will have the speed and control of an airliner that is twice the size of an Airliner operating at any altitude and at any climate conditions.

Move freely without requiring any infrastructures such as rails and wheels thus; it will saves billions of dollars on infrastructures that is required by all speed rail systems.

Since no physical infrastructures are required, it can easily connect any cities including the most remote one.

It will have the most technological advance features to fly on its own to provide the additional safety, efficiency and effectiveness.

The operating cost will be lower because it does not have to waste fuel climbing or decent to land like other airliners.

AirTrain does not require the pressurization like the airliner.

AirTrain does not require the oxygen systems as long are it is operating in the safe altitude.

Thus, it will help reduce the global emissions by depositing the co2 emission at a high altitude which is worse on the global warming.

AirTrain will operate in an airspace that is not used by the most airliners. AirTrain will operate on the surface that is from 0 to few hundred feet to get the most ground effectiveness.

AirTrain is class three ground effect vehicles that can climb to any altitude to clear most of the obstacles in our world.

AirTrain can land at any surface, if it needs to it can land and take off from the water safely and operate in and out of ground effect.

AirTrain can maneuver at the most tight areas that do not have much space like an airliner.

AirTrain does not require long runways like airliners. Thus, it will save significant cost in its operating costs.

AirTrain will free up the current congested airways and this will make the Air travel safer.

### CITATION LIST

### Patent Literature

U.S. Pat. No. 7,9000,865 B2 Mar. 8, 2011, Moore, Boren and Marques

Patent Pending Arts:

application Ser. No. 14/173,165, Art Unit 3644

and

application Ser. No. 14/176,397, Art Unit 3617

### Non Patent Literature

International Journal of Scientific & Technology Research Volume 3, Issue 8 August 2014, titled Quad copter Flight Dynamics by Mohd Khan.

1. In the prior arts symmetrically and asymmetrically joined airliners for use of the transporting cargo and people can be done as long as the joined airliners are operating low close to the surface, must maintain right altitude, and flight configurations to stay in ground effect. Ground effect is a condition all airplanes are experienced near the ground when a vortices coming off the ground are compressed to the surface that gives additional lift to the airplanes to fly with more lift and thus it is much more efficient when flying close to the surface. Unfortunate characteristic is that ground effect is very dangerous.
Many airplane accidents near the surface is ground effect related when a pilots are not properly trained to fly in ground effect and recognize its big hazard for the airplanes flying in ground effect so close to the surface. To prevent this type of ground effect accidents on airplanes is to combine the Multi Copter, multi propellers on the prior arts symmetrically combined and asymmetrically combined airliners as it was claimed in the previous claim of the prior Art Unit 3644 and 3617, two same types of airliners joined symmetrically or asymmetrically joined fuselage are combined with multi rotors, propellers and engines are attached using various materials, methods and techniques that are most safe, strengthens the two airliners and aerodynamically effective.
The multi rotors, see FIG. 1-6, multi rotors are attached to the prior arts, two airliners asymmetrically and systematically attached that would give the best balanced and aerodynamically effective and safe to operate all surfaces and all different weather conditions.
The Multi Copter AirTrain is Mass Transport Ground Effect Vehicle (MTGEV). It can easily replace any existing speed train in the world. Multi Copter AirTrain rides in the air in a ground effect thus, it does not need for any ground infrastructures such as building rails and no need to dependent on the electricity. Thus, it can save billions of dollars in eliminating the process of building the rail infrastructures and maintaining it. The multi rotors placed on the prior art mentioned above will improve the AirTrain and symmetrically joined airliners to operate in a ground effect at a close to any surface safer because it will have more control near the surface using the multi rotors in different part of the fuselage to have better control and lift in the areas where it needs it for the Airliner fuselage is safely in the air close to the surface even though it is not moving through the air.
The multi copter, rotors, propellers turning horizontal, perpendicular to the surface can provide ground effect when joined Airliners are not moving at all but it still keeps a perfect balance in a ground effect. When joined airliners are propelled forward with certain speed, near the surface at a wing span of an airliner or below, moving through the air near the surface causes dynamic form of ground effect to keep the joined airliners to fly in and out of ground effect safely though out its flight during the forward movements of the flights.
When the Multi Copter AirTrain will experience two types of ground effects, one is static ground effect when it is in the hovering over one location to maintain its positions and altitude and the other is dynamic ground effect when it the airliners wings generate when it is pushed through the air.
Multi Copter AirTrain can control effectively and efficiently both ground effects, static and dynamic ground effect which is the key to preventing any ground effect accidents near the surface with the most of the ground effect accidents by the airplanes.
The multi propellers, mounted horizontal perpendicular to the fuselage around, above or below or even on the large, major wings to give it the most efficiency in the ground effect and keep the two airliners in the air safely even at a zero movement forward but maintains its fixed designated altitude for any given time until all the fuel are used.
The multi copter combining with the patent pending AirTrain or symmetrically joined Airliners design is best for the class III Ground Effect Vehicle that can operate in out of ground effect close to any surfaces, roads, body of water, dessert, ice and snow. At the same time it can operate at a high altitude to clear any size obstacles such as mountains.
AirTrain is the combination of airliner technology, multi copter technology and unmanned aerial, UAV, technology. The AirTrain is the new concept of speed train and new mode of transportation operate in and out of ground effect safely to give the most efficient in the fuel economy, carry almost the twice as many cargo and passengers at any environment and weather conditions.
As it is shown in the FIG. 1 below is the actual working model, symmetrically joined two airliners is combined with the quad copter technology and unmanned areal technology are combined to make the AirTrain to operate at low altitude much more safer and with control.
With the prior arts symmetrically and asymmetrically combined with multi horizontal copter technology and unmanned areal vehicle technology would make the perfect combinations to make the most advanced mass ground effect transportation that can easily replace any existing speed trains of the world.
These multi engines would give additional power vertical, horizontal control and additional trust to maximize the ground effect and complete control over the movement of the vehicle to reduce the chance of crashing operating in the ground effect as with normal airplanes.
Multi Copter with unmanned aerial vehicle will have the technologically advanced functions and futures of any mass transportation can offer today. It can have a GPS hold and it can fly by using I pad or similar device by simply taking a minute to map out its course.
It will hover and fly like any unmanned areal vehicle that can be monitored and controlled at any remote location via satellite connections. It will be so easy to fly and it safe that even a 12 years old child can fly it by selecting two cities on a touch screen pad.
It can be easily programmed and updated to maintain its maximum performance in its digital systems, totally interactive and forefront any problems or future problems.
Recycling airliners, reusing the airliners that has reached its end of life. Airliners are mostly made of aluminum to keep the airliners light and on the other hand the aluminum is not as strong as other metals. Keep on flexion and inflexion will cause the aluminum to become weak and it can snap. To prevent this from happening, in FIG. 1, this is one way to extend the life of an airliner to be reused and not have to worry about the structural failures.
Recycling Airliners to build Multi Rotor AirTrain will cost only fraction of what the Airliner will cost. At the same time it can almost haul twice as many passengers like a train but it will take only a fraction of its cost to build the infrastructures and to maintain its infrastructures.
Ultimately controlling the static and dynamic ground effect will be the best way to operate safely close to surface by Multi Copter AirTrain and get most out of ground effects, increase the efficiency generate the safe lift, control and balance to prevent accidents that are common in operating near the ground.
The way to do is have a means to control horizontal and vertical movements using engines and propellers, thrust created vertically and thrust created horizontally, by using the engines that are mounted in different parts, angled and in different positions to have a complete control over the ground effect.
Unlike the airplanes, Multi Copter AirTrain will have the complete control of all three axis and be able to maintain its set requirements to operate in its capacity safely and at ease meeting its requirements to haul cargo and passengers safely at a speed greater than any existing speed train in the world.
